(19) United States
(12) Patent Application Publication
(10) Pub. No.: US 2015/0034017 A1
(43) Pub. Date: Feb. 5, 2015

(54) WASTE MANAGEMENT SYSTEM

(71) Applicant: Revier Cattle Company, Olivia, MN (US)

(72) Inventor: Thomas G. Revier, Willmar, MN (US)

(73) Assignee: Revier Cattle Company, Olivia, MN (US)

(21) Appl. No.: 13/955,972

(22) Filed: Jul. 31, 2013

(51) Int. Cl. A01K 1/01; A01K 1/015

(52) U.S. Cl. CPC A01K 1/01; A01K 1/0151
USPC 119/450; 119/436

(57) ABSTRACT

An enclosure for retaining animals within a closure wall. The enclosure includes a false floor panel having a multiplicity of orifices formed therethrough. The panel has a generally horizontal surface on which the animals can be supported. A subfloor includes a surface which is angled downwardly relative to the horizontal surface of the false floor. A plurality of generally vertical stem walls engage an underside of the false floor panel to support the panel.

### TECHNICAL FIELD

The present invention deals broadly with the field of animal husbandry. More narrowly, however, it deals with waste management and processing of byproducts of animal husbandry. Specifically, the invention deals with treating manure so as to create usable, marketable, solid and liquid fractions. Concurrently, the invention can be used to improve the air quality in an enclosure in which cattle or similar animals are captured.

### BACKGROUND OF THE INVENTION

Typically, animal husbandry, while conceded as a necessary field of endeavor, has been considered unsavory because of the deleterious odors resulting from biological waste. Air quality as a result of manure defecated by the animals being maintained has been deemed to be a very negative byproduct of the field. This negative view is generally accepted irrespective of the type of animal being attended to by feeding operations. Various types of edifices have been employed for feeding poultry, swine and dairy cattle. It will be understood that, while much of the discussion herein applies where all types of animals can be fed, the specific focus of the discussion will be dairy cattle because of relatively unique characteristics of bovine manure.

The negative perceptions of product processing and waste management are fueled by environmental, economic, public health and animal health concerns. Given proper attention, however, steps have come to be performed to improve air quality for the animals fed in the building. Flushing the floors of the barns twice each day is one step that can be taken. The situation can also be improved by reducing emissions as a result of the taking of manure in a fresh state. Further, the situation can be improved upon by optimizing nutrient capture.

Probably the most common concern in conducting feeding operations is the effects of manure from the animals. This is particularly true in the case of cattle which discharge methane gas. Methane gas can build up over time and create a situation that is unhealthy. Breathing the methane gas has been shown to be unhealthy for both the animals and the employees.

The prior art typically employs a system wherein manure is built up in the barn and is occasionally scraped or falls in between slats where buildup over time occurs. Hydrogen sulfide is produced as a result of fermentation of sulfur-containing compounds and excreted by the animals. Hydrocarbons may react with other atmospheric gasses in the presence of some light to form O₃, a critical pollutant. Because of the concerns which arise as a result of the formation of O₃, dry pulverized manure will permeate the air.

Problems are frequently encountered with regard to flushing and diffusing manure. While the manure should be liquefied to some extent, the situation is such that, while one area of the processing equipment will have a high density of manure, other areas will be devoid of any manure. This will result in cattle being stressed and render their meat in an inferior state.

It is recognized that what is needed is a system which provides economic, environmental and social benefits at the local, regional, national and eventually global levels. It is to these problems and shortcomings of the prior art that the present invention is directed. Features of the invention and advantages obtained in view of these features will become appreciated with reference to the Description of the Invention, drawing figures and appended claims.

### SUMMARY OF THE INVENTION

The present invention is an enclosure for capturing and holding cattle or other similar animals. It also functions to retain those animals within a wall defining the enclosure. The enclosure includes a false floor panel which has a multiplicity of orifices formed therethrough. It also has a generally horizontal surface which provides support for the animals. The enclosure or pen has a generally planar surface which is angled downwardly relative to the generally horizontal surface of the false floor. A plurality of generally vertical stem walls are employed. The stem walls function to engage an underside of the false floor panel. The panel is, thereby, supported by the stem walls.

In one embodiment of the invention, the stem walls are substantially parallel to one another. The stem walls, with said subfloor, define a plurality of lanes which extend downwardly from the false floor panel. It is envisioned that the generally planar surface of the subfloor is angled downwardly relative to the horizontal surface of the false floor at a one percent slope.

In the preferred embodiment, the false floor takes the form a plurality of generally parallel slats. In that embodiment, a number of adjacent slats are spaced from each other to define the orifices.

An end wall can be provided. If an end wall is included, it is intended that it intersect generally perpendicularly a plurality of stem walls.

The present invention is thus an improved waste management system. Further details of the invention and advantages obtained in view of those additional disclosures will become apparent with reference to the Detailed Description of the Invention and claims.

### BRIEF DESCRIPTION OF THE DRAWINGS

FIG. 1 is a top plan view of the geography of the present invention;

FIG. 1A is a view taken from a part of what is illustrated in FIG. 1;

FIG. 2 is a side elevational view illustrating the structure of a barn in accordance with the present invention;

FIG. 3 is a view similar to FIG. 2;

FIG. 4 is a side elevational view of a drain system in accordance with the present invention; and

FIG. 5 is a side sectional view illustrating the floor construction illustrating an enclosure in accordance with the present invention.

### DETAILED DESCRIPTION OF THE INVENTION

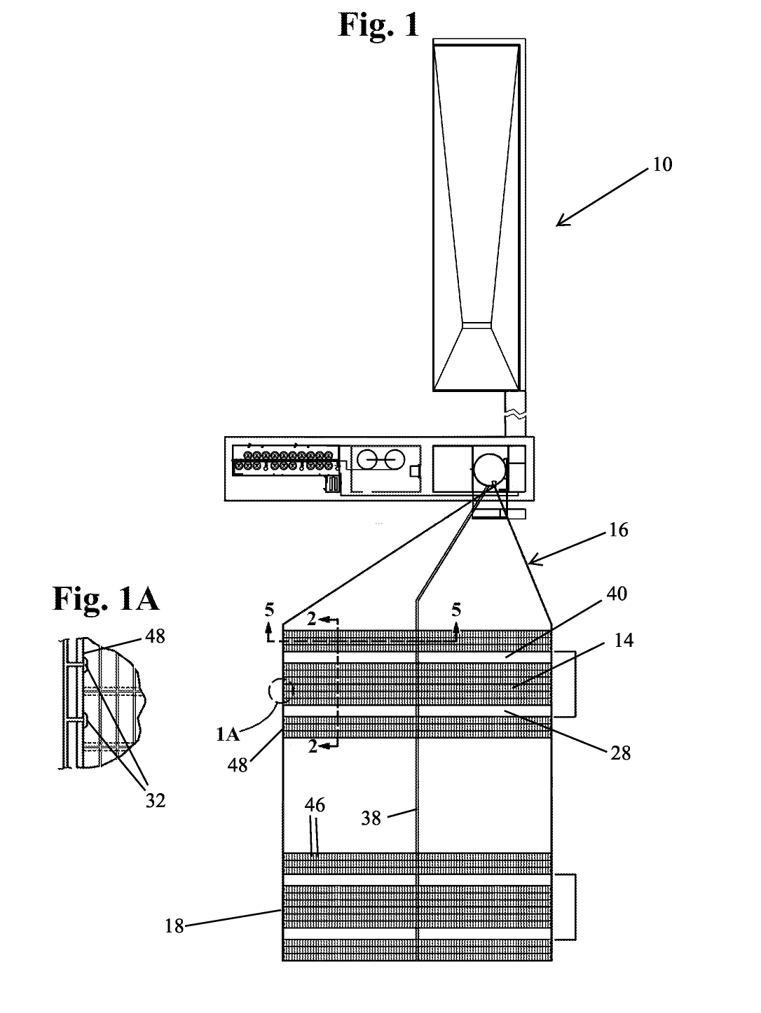

Referring now to the drawing figures wherein like reference numerals denote like elements throughout the several views, FIG. 1 illustrates an overall system 10 for feeding, as illustrated in the various figures, a large number of cattle 12, protecting the health of both the cattle and employees of the feedlot 14 on which the cattle 12 feed, and processing solid and liquid waste voided by the cattle to render such components useful and commercially practical. Included in the system is a cattle barn 16, the structure of which will be discussed in more depth hereinafter. Preliminary treatment of manure and other waste products does, however, occur in the cattle barn 16 before being conveyed to a slurry processing site 18. At this site, solid waste and liquid waste are separated for further packaging and use. Ultimately, the slurry passes to a collection area where it can be maintained.

Returning to the feedlot portion of the system 10, it can be seen that a plurality of footings 20 are embedded in the ground 22 at locations that generally approximate the shape, in plan, of the feedlot 14. At a location elevated with respect to the ground surface 22 is a false floor panel 24. This panel 24 has a generally horizontal surface 26 which provides support for the animals 12 at the feedlot 14. A multiplicity of orifices 28 are defined in the false floor panel 24 for purposes as will be seen hereinafter.

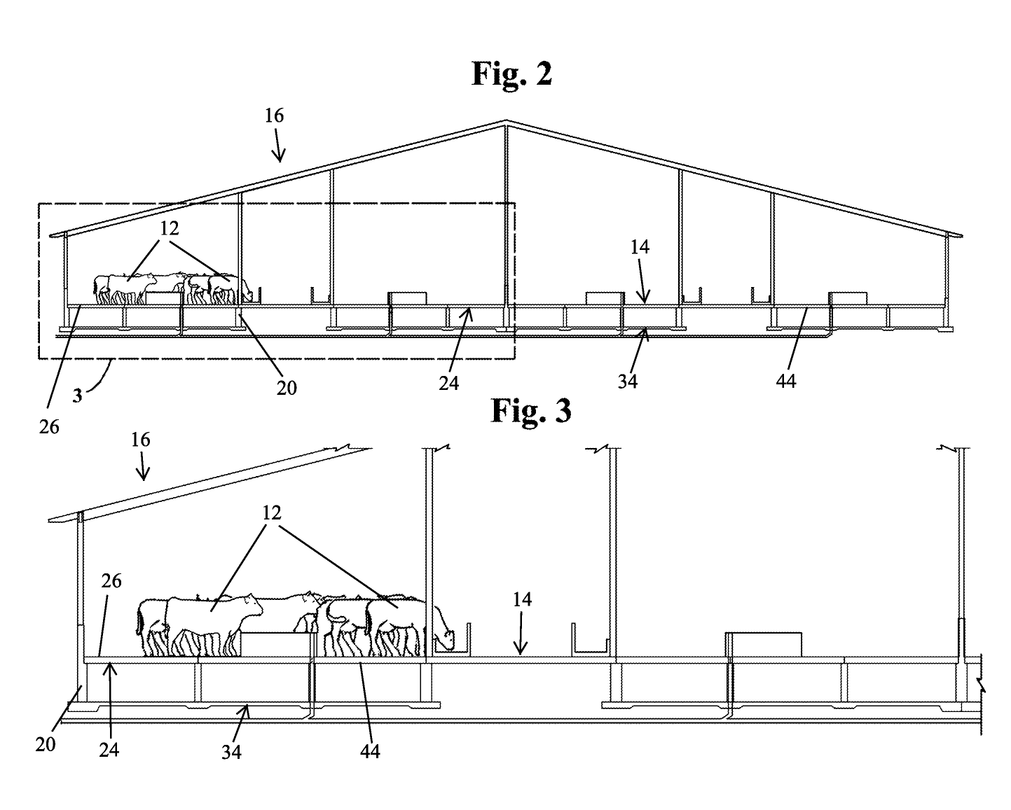

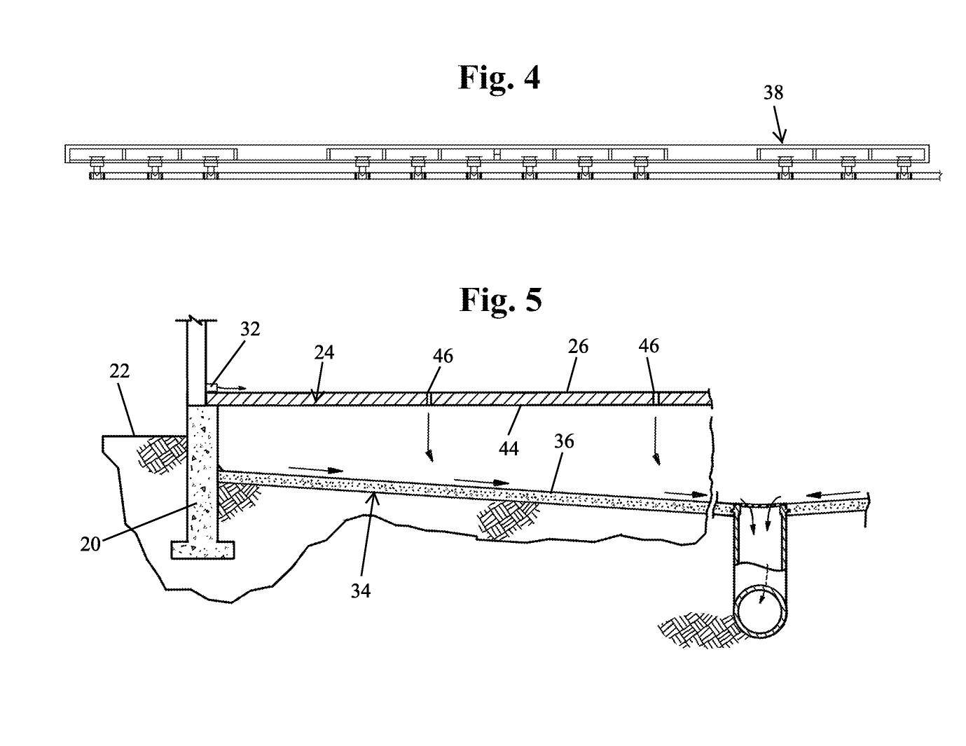

FIGS. 2 and 3 show a number of cattle 12 positioned on the false floor panel 24. A number of the cattle 12 are eating nutrient materials. It follows that bovine manure is deposited on the false floor panel 24 by cattle 12 mounted on that panel 24. Prior art structures envision flushing a surface 30 on which manure is deposited. The shortcomings of the prior art, however, preclude economization and optimization of processing. In accordance with the present invention, manure, while possibly being disproportionately spread on the false floor panel 24, is flushed by water dispensed through valves 32 mounted in end walls 48 directing the slurry-producing water across the surface 26 of the false floor panel 24. As a result, the manure is liquefied to a desired degree so that the slurry can spread out fairly uniformly across the panel 24 before passing through the orifices 28.

As best seen in FIG. 5, a subfloor 34 is positioned beneath the false floor panel 24. The subfloor 34 includes a generally planar surface 36 that is angled downwardly relative to the generally horizontal surface 26 of the false floor 24. The downward angling of the subfloor surface 26 is exaggerated for purposes of understanding the invention. It will be understood, however, that the downward angling may be as little as one percent. That is, for every 100 feet of distance along the subfloor, there will be a downward deflection of one foot. This construction not only allows for dispersion of manure across the subfloor 34, but it also provides for down-flow of the slurry to a drain 38 positioned at the bottom of the subfloor 34.

It has been found desirable to divide the subfloor 34 into a plurality of lanes 40, each having a width significantly less than the width of the subfloor 34. By providing such a construction, dispersion of manure can be further facilitated.

The lanes 40 are formed by stem walls 42 which can be substantially parallel to one another. Integrity is given to the lanes 40 by defining the lanes with the subfloor 34 in conjunction with the stem walls 42.

The plurality of generally vertical stem walls 42 typically engages an underside 44 of the false floor panel 24. The false floor panel 24 is, thereby, to support the cattle 12 and be supported by the stem walls 42.

The false floor panel 24 would typically comprise a plurality of generally parallel slats 46. In a number of spaces, the slats 46 are spaced from each other to define orifices 28 or slots therebetween. Again, the orifices 28 provide spraying of water across the generally horizontal surface 26 of the false floor panel 24.

It will be understood that the invention is intended to include a completely subterranean flow path.

It will also be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. An enclosure for capturing cattle or similar animals and retaining them within a wall defining the enclosure, comprising:
a false floor panel having a multiplicity of orifices formed therethrough, and having a generally horizontal surface, said false floor generally horizontal surface providing support for the animals;
a subfloor having a generally planar surface angled downwardly relative to said generally horizontal surface of said false floor; and
a plurality of generally vertical stem walls engaging an underside of said false floor panel to support said panel.

2. An enclosure in accordance with claim 1 wherein said generally vertical stem walls are substantially parallel to one another and define, with said subfloor, a plurality of lanes extending downwardly from said false floor panel.

3. An enclosure in accordance with claim 2 wherein said false floor comprises a plurality of generally parallel slats, at least a number of adjacent of said slats being spaced from each other to define said orifices.

4. An enclosure in accordance with claim 1 wherein said subfloor comprises multiple, downwardly extending surfaces which angle downwardly from said false floor and intersect each other.

5. An enclosure in accordance with claim 4 wherein said downwardly extending surfaces intersect each other generally centrally between lines of intersection of said downwardly extending surfaces with said false floor.

6. An enclosure in accordance with claim 2 further comprising an end wall intersecting generally perpendicularly a plurality of stem walls.

7. An enclosure in accordance with claim 6 wherein said enclosure is confined within a first building.

8. An enclosure in accordance with claim 7 further comprising a second building to which manure defecated by animals on said false floor is conveyed, the manure there being separated from a liquid fraction eliminated by the animals.

9. An enclosure in accordance with claim 2 further comprising means for flushing manure across said false floor panel.

10. An enclosure in accordance with claim 1 wherein said generally planar surface of said subfloor is angled downwardly relative to said generally horizontal surface of said false floor at a one percent slope.

11. An enclosure in accordance with claim 10 wherein said generally vertical stem walls are substantially parallel to one another and define, with said subfloor, a plurality of lanes extending downwardly from said false floor panel.

12. A system for separating a solid fraction of waste material defecated by cattle or similar animals from a liquid fraction of the waste material eliminated by the animals, comprising:
a first building housing means for distributing the solid and liquid fractions of the waste material among a plurality of lanes extending downwardly from a generally horizontal false floor panel supporting the animals to disperse the waste material among said lanes; and
a second building to which the waste material is conveyed from said first building by gravity, said second building including means for separating the solid and liquid fractions.
